(19) United States
(12) Patent Application Publication
(10) Pub. No.: US 2011/0137958 A1
(43) Pub. Date: Jun. 9, 2011

(54) Implementation Method of DATACOM Data Command Platform

(75) Inventors: GUOMIN HANG, Nanjing (CN); Shan Chen, Nanjing (CN); Bin Liang, Nanjing (CN); Hua Li, Nanjing (CN); Libin Sun, Nanjing (CN); Fan Zhang, Nanjing (CN)

(73) Assignee: LINKAGE TECHNOLOGY GROUP CO., LTD., Nanjing (CN)

(21) Appl. No.: 12/962,643

(22) Filed: Dec. 7, 2010

(30) Foreign Application Priority Data
Dec. 9, 2009 (CN) 200910232394.2

(51) Int. Cl. G06F 7/00; G06F 17/30

(52) U.S. Cl. 707/809; 707/E17.006

(57) ABSTRACT

Implementation method of DATACOM Data command platform, taking the characteristic of data business into account, DATACOM system working on the data command platform, which is both data processor and data general converter, completes both command protocol conversion and command contents conversion, after the conversion of the opening command of data business from BOSS to the opening command of network element (NE) data, business opening, including single business and a batch of business, NE scheduling and load balancing are all achievable. Meanwhile, troubles are compatible; comprising following steps: 1) Data Source Configuration; 2) Configuration of Data Source Differences; 3) Data Command Configuration; 4) NE Data Configuration; 5) Configuration of Generating Data Command; this method stores the command in a configuration table, splitting the command content into records of the table. The relation between the records forms a tree structure, which can present either XML format or fixed length string, the program generates the command content in accordance with this structure.

### CROSS REFERENCE TO RELATED PATENT APPLICATION

The present application claims the priority of Chinese patent application No. 200910232394.2 filed on Dec. 9, 2009, which application is incorporated herein by reference.

### FIELD OF THE INVENTION

This invention is a management procedure of command scheduling about BOSS data business opening command and NE data opening command processing.

### BACKGROUND OF THE INVENTION

Value-added service is the direction of mobile telecommunication business development, which is bound to become dominant in mobile telecommunication business system as times goes on. In 3G era, value-added service is also what the operators focus on. Since the amount of this service increases as the custom expends from individual to group, commands between BOSS and NE become more and more complicated, and system upgrading becomes more and more frequent. Therefore, this system should shield the diversity of NE data command protocols, improve system stability and simplify updating process. BOSS system offers a business operation and management platform for telecommunication and network operators and puts forward a comprehensive solution, taking custom service and business operation and management as the kernel and the key transaction operation-custom service and accounting—as the primary function.

DATACOM system is an important module of BOSS, mainly including data general conversion and protocol adapter module.NE, composed of single or multiple boards or frames, is a set which is able to transmit independently, such as PDH, SDH-ADM, DACS, TEM, REG and PCM.

The processing of BOSS data business opening command and NE data opening command in DATACOM is a management procedure of command scheduling.

### SUMMARY OF THE INVENTION

Differences among NE data commands should be hided to BOSS system. This invention provides a way to realize command protocol and content conversion, command transmission order control and load balance. Through the reversible conversion of the opening command of data business from BOSS to the opening command of network element (NE) data, data scheduling, monitoring, alarming, features of different network elements get compatible. In this way, business opening, including single business and a batch of business, NE scheduling and load balancing are all achievable. Meanwhile, troubles are compatible.

The implementation method of DATACOM data command platform is as follows.

Taking the characteristic of data business into account, DATACOM system working on the data command platform, which is both data processor and data general converter, completes both command protocol conversion and command contents conversion; After the conversion of the opening command of data business from BOSS to the opening command of network element (NE) data, business opening, including single business and a batch of business, NE scheduling and load balancing are all achievable. Meanwhile, troubles are compatible.

(1) Data Source Configuration: Since all the business commands like opening/canceling from BOSS share a scheduling table and lots of NE, such as ADC, MAC, Fetion, mobile music club, CRBT, VGOP, DSMP and etc., bring about large amounts of this business data, the scheduling table should be split. In this condition, the name of data source table should be configured by some parameters before fetching data to ensure the consistence between applications. DataCom application assigns itself a fixed ID according to which the right data source table name of this application can be fetched from parameter table. In this way, it ensures the data source is configurable.

(2) Configuration of Data Source Differences: For the sake of configuring data source as former steps, source data provider should know about the source data on the basis of existing configurations to guarantee the accuracy of data sent before sending. Therefore, a set of tables for data accuracy check before sending source data is designed in DataCom application.

(3) Data Command Configuration: While data passes the platform, data command can be generated directly by configuring data command but not modifying program and sent to the corresponding receiving NE.

(4) NE Data Configuration: There have been multitudes of NE Furthermore, this size increases with the development of business. This system offers a selective Data command transmitting if different network elements need to be transmitted to. In case many interdependent network elements should be sent to, this business will be dealt with according to the interdependency.

There is a preprocessing before fetching data into cache. For one trade, it perhaps needs to send command to many network elements or send many commands to a network element. It is necessary to adjust the dependency relationship between data and the priority of command sending. If there is some causality, the relation information and the executing order are also need to be set. The commands with the same causal relation information should be executed according to the order set up one after another. When an exception is thrown out, the subsequent commands will be terminated consequently. There are some executing schemas about preprocessing. If there is a series of businesses to be handled in sequence for the same number, it can be done by the way of changing some configuration of this trade, such as defining a script using Javascript or a procedure, regulating data by SQL statements, to combine one or several schemas.

After decomposition, the command is recomposed according to command ID and NE ID in line with the feature of NE.

(5) Configuration of Generating Data Command: Data command consists of command head and command body, which are both different as a result of the differences between network elements. For example, some NE offers a command header integrating the functions of head and body since there are descriptions in head part about operation defined in body part. Therefore, when command generated, the head should be got according to the corresponding NE kind and then the body could be got from the corresponding data source.

After reading command information, DATACOM would get configuration information referring to the key constituted by NE and command ID for different network elements. Data command can be assembled in many ways: 1)The command in XML format, is firstly translated to the data in general XML format, and then converted to the information in the required XML format by the NE through XSLT conversion, the first step of which is reading the XSLT configuration file with the Key. 2) For the command which has a large amount of data and desires a very high performance, the required XML format by the NE can be got directly by analytical adapter (analytical class). The Key dependent on the information of the interface determines which analytical adapter is suitable. After loading the suitable analytical adapter, content of the command is converted to the information in final XML format. 3)For the command which has a lower requirement about performance than former, dynamical analysis is also practicable. This method stores the command in a configuration table, splitting the command content into records of the table. The relation between the records forms a tree structure, which can present either XML format or fixed length string. The program generates the command content in accordance with this structure.

(6) the Supporting Mechanism of Multiprocess: When processing data with single data source, this platform configures the kind of the involved NE to sustain this characteristic.

(7) the Supporting Mechanism of Multithread: When processing data with single data source, this platform starts any number of threads. Each thread deals with data from the corresponding NE.

(8) the Portability of Applications: It's applicable for the data interaction between network elements of all telecommunication operators such as China Mobile, China Unicom and China Telecommunications. To process different commands, only the configuration, not the scheduling program, needs to be changed.

Through the reversible conversion of the opening command of data business from BOSS to the opening command of network element (NE) data, data scheduling, monitoring, alarming, features of different network elements get compatible. In this way, business opening, including single business and a batch of business, NE scheduling and load balancing are all achievable. Meanwhile, troubles are compatible. Moreover, through packaging, the protocol adapter unit, the format configuration unit and the particular business processing unit, diversity of NE is shielded. Convertible command protocol convertible includes HTTP receiving/sending, Tuxedo invoking/invoked, SMS interface, Soap, ftp, MML, Socket. In addition, format conversion of XML and string split by symbols and command content conversion which is configurable are completed, too. This invention hides the business transaction differences between BOSS and NE, and accelerates the business processing by using producer and consumer thread, and take full advantage of host resources.

### BRIEF DESCRIPTION OF THE DRAWINGS

FIG. 1 the logical of processing unit

FIG. 2 the relationship of interface

FIG. 3 the processing of data command business

FIG. 4 the instance of processing module

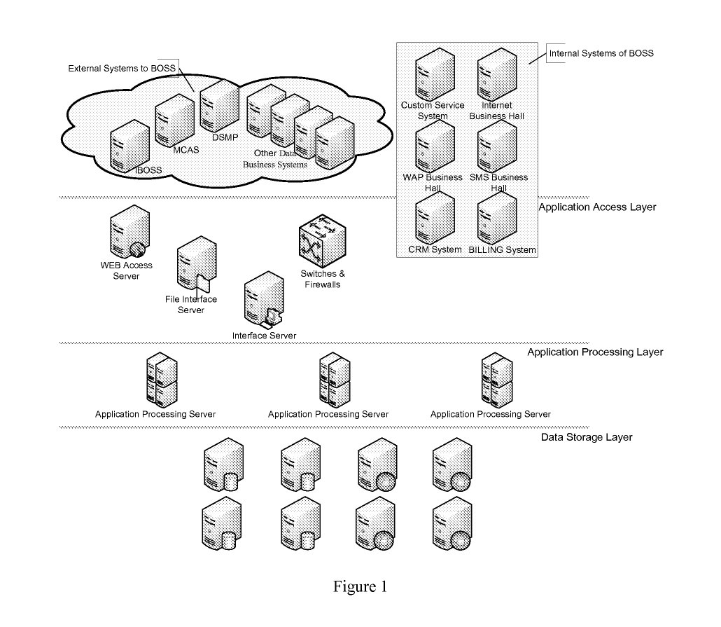

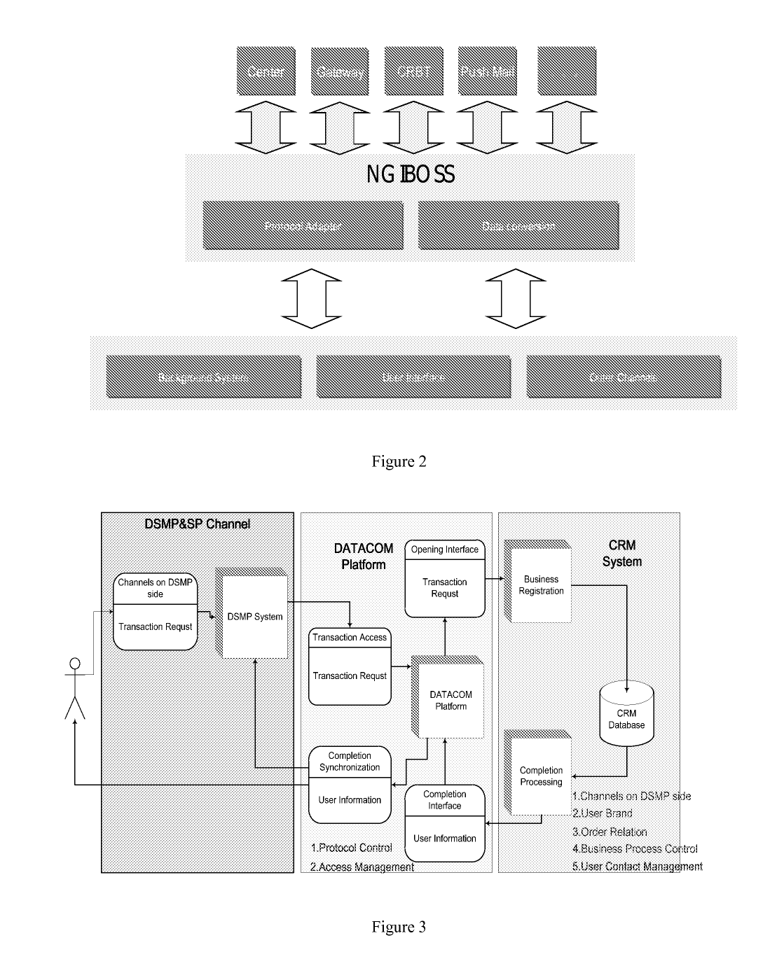

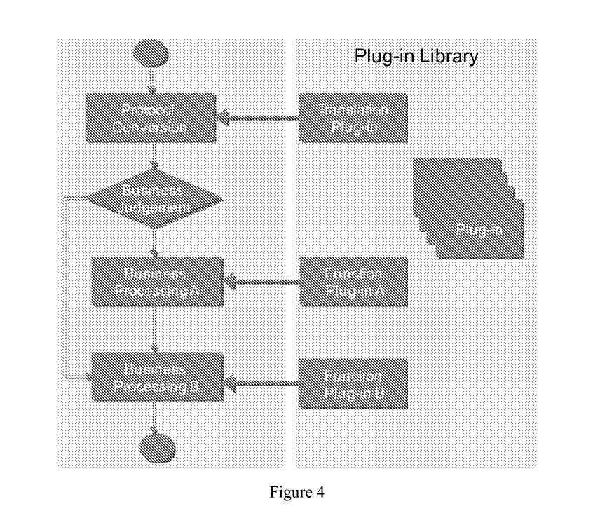

### DETAIL DESCRIPTION OF THE INVENTION

Through packaging the protocol adapter unit, the format configuration unit and the particular business processing unit, diversity of NE is shielded. Convertible command protocol includes HTTP receiving/sending, Tuxedo invoking/invoked, SMS interface, Soap, ftp, MML, Socket. In addition, format conversion of XML and string split by symbols and command content conversion which is configurable are completed, too.

Data scan/distribution unit takes charge of data extraction, multi-host load balance, command sending control between many network elements. In addition, Command scheduling works on the basis of business priority, command sending order and command amount.

Considering the differences between BOSS commands and NE commands, through the reversible conversion of the opening command of data business from BOSS to the opening command of network element (NE) data after configuring appropriately, data scheduling, monitoring, alarming, features of different network elements get compatible. In this way, business opening, including single business and a batch of business, NE scheduling and load balancing are all achievable. Meanwhile, troubles are compatible.

Data conversion and command transmission are controlled by five threads-Data extraction thread, data processing thread, data feedback thread, data callback thread, general scheduling thread. Functions are simply described as follows.

1) Protocol Adapter Unit

This unit is responsible for conversion of command protocol like HTTP receiving/sending, Tuxedo invoking/invoked, SMS interface, Soap, ftp, MML, Socket and command protocol format.

2) Data Scan/Distribution Unit

This unit takes charge of data extraction, multi-host load balance, command sending control between many network elements. In addition, Command scheduling works on the basis of business priority, command sending order and command amount.

3) Format Configuration Unit

This unit is responsible for configuring the conversion mode of the given data in database. And then the whole command content is possible to be expressed in the target format.

4) Particular Business Processing Unit

For some complicate transactions which cannot be processed only by configuration, other flexible measures like programming are taken to describe the format and fulfill the conversion in this unit.

5) Data Callback Unit

This unit is used to process business feedback information.

There is a limit of allowable failure times when loading order information into relay database. If the number of actual failure times is less than the limit, this order would be thrown back for reprocessing. If the number of actual failure times has exceeded the limit, the system would send a short message to notify the administrator to deal.

This system sorts transactions in memory, basing on time information, to filter those which are illogical among the mass data distributed by partners.

When there is a large amount of user information to be loaded, this system adopts rapid processing in groups or channels according to logical keyword to ensure the latest information to be passed to BOSS in limit duration. Aiming to improve the performance of background processing, transactions are invoked by producer or consumer thread packaged. The producer collect objects into shared queue, namely channel, in which data queue up upon certain logic. Many consumer threads are started to come by data from the shared queue simultaneously. Therefore, processing is accelerated.

### Example of Command Configuration

The first table necessary to configure is the table of business configuration information (TD_B_IBBUSI_SIGN). The fields are as follows.

### 1. BUSI_SIGN:

This is the identification of a business. Different values of BUSI_SIGN should be defined for different businesses,

### 2. X_TRANS_CODE

This is the identification of a transaction invoking, which is used for distinguishing between CRM and BILLING service or filtration according to transaction type in internal system.

### 3. SERV_TYPE

It is the identification of a network element, valued according to the requirement of platform, such as VGOP, DSMP.

### 4. DIRECTION

This field shows the transaction direction.
0—Originate
1—Home

### 5. RSLT_SYN_STATE

This field shows whether to return processing result asynchronously or not. The value “0” means return synchronously while “1” means return asynchronously.

### 6. SYS_CODE

This is the code of the platform in China Mobile.

### 7. TEST_FLAG

“0” represents this business is formal and “1” represents informal.

### 8. PROTOCOL_NAME

This field shows the protocol name. Concretely, the first bit indicates the protocol, the value of which could be “0”, “1”, “2”, “3” and “4” coincidently corresponding to HTTP, SOCKET, web service, Tuxedo and file protocol. The second bit indicates the data format, the value of which could be “0” and “1” coincidently corresponding to XML and text format. The two bits left indicate the sub type. For instance,“00” directs XML format with a header, “0001” directs XML format without a header, “1100” directs a piece of SOCKET text.

### 9. SEND_NO

This field means how many times the transaction should be sent, with “1” as the default value.

### 10. THREAD_COUNT

This field is used for set the amount of threads for synchronous processing.

### 11. SLEEP_TIME

This field shows the sleeping duration of threads in milliseconds. This value is inversely proportional to the amount of system resources occupied.

### 12. SEND_INTERVAL_SAMETYPE

This field represents the interval between two transmissions in milliseconds on condition that the message number has exceeded the limit of GROUP_NUM field in former transmission. That is to say, it works only when there's an accumulation of data.

### 13. GROUP_MAX_NUM

This indicates the maximum number of the message in one transmission. The value should be set in the light of actual conditions. For the case of single business, it should be “1”.

### 14. GROUP_MIN_NUM

This indicates the minimum number of the message in one transmission. The value should be set in the light of actual conditions. For the case of single business, it should be “0”.

### 15. MAX_SEGMENT

It points the maximum interval between two transmissions in seconds. The value “−1” expresses this limit doesn't work.

### 16. ERR_INTERVAL_TIME

This expresses the interval in seconds between two transmissions in the case of the former sending failure. Only if retransmission been set, this field is effective.

### 17. PKG_BATCH_FLAG

This field shows whether to send a batch of data or batches of data, offering a basis for judging whether a batch of data can be packaged in a message or not. The value “0” means sending a batch of data, and the value “1” means batches.

### 18. BEGIN_{—TIME. END}_TIME

These two fields suggest whether this record is effective or not.

Referring to the NE command configuration, the header configuration and the body configuration can be carried out separately, with the custom conversion configuration or general conversion configuration information loaded. The concrete configuration is as follows:

Following three tables needs to be configured in general conversion.
the table for platform data synchronization format definition (TD_B_IBDEFINITION_STRUCTURE)
the table for platform data synchronization simple corresponding escape (TD_B_IBSIMPLE_ESCAPE)
the table for platform data synchronization function escape (TD_B_IBCOMPLEX_ESCAPE)

### TD_B_IDEFINITION_STRUCTURE

Main table for general conversion, configuring the transforming formulas for data in XML and BML structure with configurations in table TD_B_IBSIMPLE_ESCAPE and TD_B_IBCOMPLEX_ESCAPE.

| | | DEFINITION_ID | | BUSI_SIGN | | BML2XML | TYPE | XML_NAME | |
|---|---|---|---|---|---|---|---|---|---|
| [symbol] | 1 | BIP68643_T6101604_1_01_0 | . . . | BIP68643_T6101604_1_0 | . . . | 1 | 04 | LIDRR_{sP} | . . . |
| | 2 | BIP68643_T6101604_1_01_1 | . . . | BIP68643_T6101604_1_0 | . . . | 1 | 11 | RspPkgSeq | . . . |
| | 3 | BIP68643_T6101604_1_01_2 | . . . | BIP68643_T6101604_1_0 | . . . | 1 | 11 | CrtT | . . . |
| | 4 | BIP68643_T6101604_1_01_3 | . . . | BIP68643_T6101604_1_0 | . . . | 1 | 11 | ReceivedSur | . . . |
| | 5 | BIP68643_T6101604_1_01_4 | . . . | BIP68643_T6101604_1_0 | . . . | 1 | 11 | SuccSum | . . . |
| | 6 | BIP68643_T6101604_1_01_5 | . . . | BIP68643_T6101604_1_0 | . . . | 1 | 11 | FailedSum | . . . |
| | 7 | BIP68643_T6101604_1_01_6 | . . . | BIP68643_T6101604_1_0 | . . . | 1 | 03 | FailedB Date | . . . |
| | 8 | BIP68643_T6101604_1_01_7 | . . . | BIP68643_T6101604_1_0 | . . . | 1 | 11 | OpiNumb | . . . |
| | 9 | BIP68643_T6101604_1_01_8 | . . . | BIP68643_T6101604_1_0 | . . . | 1 | 11 | MSISON | . . . |
| | 10 | BIP68643_T6101604_1_01_9 | . . . | BIP68643_T6101604_1_0 | . . . | 1 | 11 | Rslt | . . . |
| | 11 | BIP68643_T6101604_1_01_10 | . . . | BIP68643_T6101604_1_0 | . . . | 1 | 11 | CrtT | . . . |

| | | XML_PARE_ID | | XML_PARE_NAME | | SEQ | | BUFFER_NAME | | TI |
|---|---|---|---|---|---|---|---|---|---|---|
| [symbol] | 1 | N/A | | N/A | | 0 | | N/A | | 00 |
| | 2 | BIP68643_T6101604_1_01_0 | . . . | UDRRsp | . . . | 0 | . . . | PKG_ID | . . . | 00 |
| | 3 | BIP68643_T6101604_1_01_0 | . . . | UDRRsp | . . . | 1 | . . . | RETURN_ID | . . . | 01 |
| | 4 | BIP68643_T6101604_1_01_0 | . . . | UDRRsp | . . . | 2 | . . . | RECEIVED_SUM | . . . | 00 |
| | 5 | BIP68643_T6101604_1_01_0 | . . . | UDRRsp | . . . | 3 | . . . | SUCC_SUM | . . . | 00 |
| | 6 | BIP68643_T6101604_1_01_0 | . . . | UDRRsp | . . . | 4 | . . . | FAILED_NUM | . . . | 00 |
| | 7 | BIP68643_T6101604_1_01_0 | . . . | UDRRsp | . . . | 5 | . . . | TRANS_ID | . . . | 00 |
| | 8 | BIP68643_T6101604_1_01_6 | . . . | FailedB Data | . . . | 0 | . . . | TRANS_ID | . . . | 00 |
| | 9 | BIP68643_T6101604_1_01_6 | . . . | FailedB Data | . . . | 1 | . . . | IS_SUCCESS | . . . | 01 |
| | 10 | BIP68643_T6101604_1_01_6 | . . . | FailedB Data | . . . | 2 | . . . | REMOTE_RSLT_CODE1 | . . . | 00 |
| | 11 | BIP68643_T6101604_1_01_0 | . . . | UDRRsp | . . . | 1 | . . . | PKG_IS_SUCCESS | . . . | 01 |

The field DEFINITION_ID is regulated to be defined as “BUSI_SIGN+BML2XML+”_“NO”.

The field BML2XML could be assigned to as follows:
0-BML2XML 1-XML2BML

The field TYPE shows the type of the node and could be assigned to as follows:
00—The node has an xml structure, be classified as “?”
01—The node has a xml structure, be classified as “1”
02—The node has a xml structure, be classified as “*”
03—The node has a xml structure, be classified as “+”
04—The node is the top of a XML structure
10—The node is an xml structure text, be classified as “?”
11—The node is a xml structure text, be classified as “1”
12—The node is a xml structure text, be classified as “*”
13—The node is a xml structure text, be classified as “+”
   The Corresponding Relation between Business Standard and Table

### APPLICATION EXAMPLES

### Order Relation Synchronization

(1) The node SvcCont of Request

| | FATHER | | | | | | EXPLANATION |
|---|---|---|---|---|---|---|---|
| SEQUENCE | ELEMENT | ELEMENT | | | | | OF THE |
| NUMBER | NAME | NAME | CONSTRAINT | TYPE | WIDTH | DESCRIPTION | VALUE |
| 14 | ProvBOSS | SvcCont | 1 | — | — | the | string in XML |
| | | | | | | content of | format |
| | | | | | | the | translated into |
| | | | | | | request | CDATA |
| | | | | | | | structure |
| 14.1 | SvcCont | UDRRsp | 1 | — | — | the | string in XML |
| | | | | | | content of | format |
| | | | | | | the | translated into |
| | | | | | | request | CDATA |
| | | | | | | | structure |
| 14.1.1 | UDRRsp | RspPkgSeq | 1 | String | V19 | request | Rsp+ PkgSeq in |
| | | | | | | package | order relation |
| | | | | | | sequence | synchronization |
| | | | | | | number | request |
| 14.1.2 | UDRRsp | CrtT | 1 | String | F14 | The time | YYYYMMDD |
| | | | | | | of | HHMISS |
| | | | | | | generating | |
| | | | | | | confirmation | |
| | | | | | | transaction | |
| | | | | | | package | |
| 14.1.3 | UDRRsp | Received | 1 | String | V4 | the | |
| | | Sum | | | | number | |
| | | | | | | of | |
| | | | | | | records | |
| | | | | | | received | |
| 14.1.4 | UDRRsp | SuccSum | 1 | String | V4 | the | |
| | | | | | | number of | |
| | | | | | | records | |
| | | | | | | processed | |
| | | | | | | successfully | |
| 14.1.5 | UDRRsp | FailedSum | 1 | String | V4 | the | |
| | | | | | | number of | |
| | | | | | | records | |
| | | | | | | processed | |
| | | | | | | unsuccessfully | |
| 14.1.6 | UDRRsp | FailedB | * | — | — | details of | |
| | | Data | | | | failed | |
| | | | | | | records | |
| 14.1.6.1 | FailedB | OprNumb | 1 | String | V22 | operating | the value of |
| | Data | | | | | sequence | OprNumb in |
| | | | | | | number of | order relation |
| | | | | | | failed | synchronization |
| | | | | | | records | request |
| 14.1.6.2 | FailedB | MSISDN | 1 | String | V32 | mobile | |
| | Data | | | | | number | |
| 14.1.6.3 | FailedB | Rslt | 1 | String | F2 | result | Two bits |
| | Data | | | | | code | |

### Description of Columns:

The last bit of the column SEQUENCE NUMBER is corresponded to the field SEQ of TD_B_IBDEFINITION_STRUCTURE which shows the sequence number of this element in its father element. For instance, “14.1.1”—means the value of SEQ is “1”.

The column FATHER ELEMENT NAME is corresponded to the field XML_PARE_NAME of TD_B_IBDEFINITION_STRUCTURE.

The column ELEMENT NAME is corresponded to the field XML_NAME of TD_B_IBDEFINITION_STRUCTURE.

The column CONSTRAINT is corresponded with the field TYPE of TD_B_IBDEFINITION_STRUCTURE, with the former value “0” corresponded the latter value “00” or “10”, the former value “1” corresponded the latter value “01” or “11”, the former value “*” corresponded the latter value “02” or “12”, the former value “+” corresponded the latter value “03” or “13”.

### Order Relation Synchronization Confirmation: (1) the Node SvcCont of Request

| | FATHER | | | | | | EXPLANATION |
|---|---|---|---|---|---|---|---|
| SEQUENCE | ELEMENT | ELEMENT | | | | | OF THE |
| NUMBER | NAME | NAME | CONSTRAINT | TYPE | WIDTH | DESCRIPTION | VALUE |
| 14 | ProvBOSS | SvcCont | 1 | — | — | the | string in XML |
| | | | | | | content of | format |
| | | | | | | the | translated into |
| | | | | | | request | CDATA |
| | | | | | | | structure |
| 14.1 | SvcCont | UDRRsp | 1 | — | — | the | string in XML |
| | | | | | | content of | format |
| | | | | | | the | translated into |
| | | | | | | request | CDATA |
| | | | | | | | structure |
| 14.1.1 | UDRRsp | RspPkgSeq | 1 | String | V19 | request | Rsp+ PkgSeq in |
| | | | | | | package | order relation |
| | | | | | | sequence | synchronization |
| | | | | | | number | request |
| 14.1.2 | UDRRsp | CrtT | 1 | String | F14 | The time | YYYYMMDD |
| | | | | | | of | HHMISS |
| | | | | | | generating | |
| | | | | | | confirmation | |
| | | | | | | transaction | |
| | | | | | | package | |
| 14.1.3 | UDRRsp | Received | 1 | String | V4 | the | |
| | | Sum | | | | number of | |
| | | | | | | records | |
| | | | | | | received | |
| 14.1.4 | UDRRsp | SuccSum | 1 | String | V4 | the | |
| | | | | | | number of | |
| | | | | | | records | |
| | | | | | | processed | |
| | | | | | | successfully | |
| 14.1.5 | UDRRsp | FailedSum | 1 | String | V4 | the | |
| | | | | | | number of | |
| | | | | | | records | |
| | | | | | | processed | |
| | | | | | | unsuccessfully | |
| 14.1.6 | UDRRsp | FailedB | * | — | — | details of | |
| | | Data | | | | failed | |
| | | | | | | records | |
| 14.1.6.1 | FailedB | OprNumb | 1 | String | V22 | operating | the value of |
| | Data | | | | | sequence | OprNumb in |
| | | | | | | number of | order relation |
| | | | | | | failed | synchronization |
| | | | | | | records | request |
| 14.1.6.2 | FailedB | MSISDN | 1 | String | V32 | mobile | |
| | Data | | | | | number | |
| 14.1.6.3 | FailedB | Rslt | 1 | String | F2 | result | Two bits. |
| | Data | | | | | code | |

### Configurations in TD_B_IBDEFINITION_STRUCTURE:

| | | | | |
|---|---|---|---|---|
| BIP6B643_T6101602_0_00_0 | BIP6B643_T6101602_0_0 | 0 | 4 | UDR |
| BIP6B643_T6101602_0_00_1 | BIP6B643_T6101602_0_0 | 0 | 11 | PkgSeq |
| BIP6B643_T6101602_0_00_2 | BIP6B643_T6101602_0_0 | 0 | 11 | UDSum |
| BIP6B643_T6101602_0_00_3 | BIP6B643_T6101602_0_0 | 0 | 3 | UD |
| BIP6B643_T6101602_0_00_4 | BIP6B643_T6101602_0_0 | 0 | 11 | Opr |
| | | | | Numb |
| BIP6B643_T6101602_0_00_5 | BIP6B643_T6101602_0_0 | 0 | 11 | IDVA |
| BIP6B643_T6101602_0_00_6 | BIP6B643_T6101602_0_0 | 0 | 10 | IDVB |
| BIP6B643_T6101602_0_00_7 | BIP6B643_T6101602_0_0 | 0 | 11 | Opr |
| BIP6B643_T6101602_0_00_8 | BIP6B643_T6101602_0_0 | 0 | 10 | Chg |
| | | | | Flg |
| BIP6B643_T6101602_0_00_9 | BIP6B643_T6101602_0_0 | 0 | 10 | BillFlg |
| BIP6B643_T6101602_0_00_10 | BIP6B643_T6101602_0_0 | 0 | 1 | BizOrder |
| BIP6B643_T6101602_0_00_11 | BIP6B643_T6101602_0_0 | 0 | 11 | SPID |
| BIP6B643_T6101602_0_00_12 | BIP6B643_T6101602_0_0 | 0 | 11 | SPBiz |
| | | | | Code |
| BIP6B643_T6101602_0_00_13 | BIP6B643_T6101602_0_0 | 0 | 11 | Source |
| BIP6B643_T6101602_0_00_14 | BIP6B643_T6101602_0_0 | 0 | 2 | OprInfo |
| BIP6B643_T6101602_0_00_15 | BIP6B643_T6101602_0_0 | 0 | 11 | Icode |
| BIP6B643_T6101602_0_00_16 | BIP6B643_T6101602_0_0 | 0 | 11 | Ivalue |
| BIP6B643_T6101602_0_00_17 | BIP6B643_T6101602_0_0 | 0 | 10 | Channel |
| BIP6B643_T6101602_0_00_18 | BIP6B643_T6101602_0_0 | 0 | 11 | EfftT |
| BIP6B643_T6101602_0_00_19 | BIP6B643_T6101602_0_0 | 0 | 10 | EndT |
| BIP6B643_T6101602_0_00_20 | BIP6B643_T6101602_0_0 | 0 | 11 | CrtT |

| | | | | | |
|---|---|---|---|---|---|
| N/A | N/A | 0 | N/A | 0 | N/A |
| BIP6B643_T6101602_0_00_0 | UDR | 1 | LOGPKG_ID | 0 | N/A |
| BIP6B643_T6101602_0_00_0 | UDR | 2 | LOGBD_SUM | 0 | N/A |
| BIP6B643_T6101602_0_00_0 | UDR | 3 | SERIAL_NUMBER | 0 | N/A |
| BIP6B643_T6101602_0_00_3 | UD | 0 | TRANS_ID | 0 | N/A |
| BIP6B643_T6101602_0_00_3 | UD | 1 | SERIAL_NUMBER | 0 | N/A |
| BIP6B643_T6101602_0_00_3 | UD | 2 | SUB.GIF_SERIAL_NUMBER | 0 | N/A |
| BIP6B643_T6101602_0_00_3 | UD | 3 | OPER_CODE | 0 | N/A |
| BIP6B643_T6101602_0_00_3 | UD | 4 | CHGFLG | 0 | N/A |
| BIP6B643_T6101602_0_00_3 | UD | 5 | BILL_TYPE | 0 | N/A |
| BIP6B643_T6101602_0_00_3 | UD | 6 | SP_CODE | 0 | N/A |
| BIP6B643_T6101602_0_00_10 | Biz | 0 | SP_CODE | 0 | N/A |
| | Order | | | | |
| BIP6B643_T6101602_0_00_10 | Biz | 1 | BIZ_CODE | 0 | N/A |
| | Order | | | | |
| BIP6B643_T6101602_0_00_3 | UD | 7 | OPR_SOURCE | 0 | N/A |
| BIP6B643_T6101602_0_00_3 | UD | 8 | SUB.DSMP_INFO_CODE | 0 | N/A |
| BIP6B643_T6101602_0_00_14 | Opr | 0 | SUB.DSMP_INFO_CODE | 0 | N/A |
| | Info | | | | |
| BIP6B643_T6101602_0_00_14 | Opr | 1 | SUB.DSMP_INFO_VALUE | 0 | N/A |
| | Info | | | | |
| BIP6B643_T6101602_0_00_3 | UD | 9 | CHANNEL_CODE | 0 | N/A |
| BIP6B643_T6101602_0_00_3 | UD | 1 0 | ACCEPT_DATE | 0 | N/A |
| BIP6B643_T6101602_0_00_3 | UD | 1 1 | END_DATE | 0 | N/A |
| BIP6B643_T6101602_0_00_0 | UDR | 0 | LOG.CRTT | 0 | N/A |

### TD_B_IBDEFINITION_STRUCTURE

| | | | | | | | | | | |
|---|---|---|---|---|---|---|---|---|---|---|
| BIP6B64 | BIP6B64 | 1 | 4 | UDR | N/A | N/A | 0 | N/A | 0 | N/A |
| 3_T6101 | 3_T6101 | | | Rsp | | | | | | |
| 604_1_0 | 604_1_0 | | | | | | | | | |
| 1_0 | | | | | | | | | | |
| BIP6B64 | BIP6B64 | 1 | 11 | RspPkgSeq | BIP6B643_T | UDR | 0 | PKG_ID | 0 | N/A |
| 3_T6101 | 3_T6101 | | | | 6101604_1_0 | Rsp | | | | |
| 604_1_0 | 604_1_0 | | | | 1_0 | | | | | |
| 1_1 | | | | | | | | | | |
| BIP6B64 | BIP6B64 | 1 | 11 | CrtT | BIP6B643_T | UDR | 1 | CRTT | 0 | N/A |
| 3_T6101 | 3_T6101 | | | | 6101604_1_0 | Rsp | | | | |
| 604_1_0 | 604_1_0 | | | | 1_0 | | | | | |
| 1_2 | | | | | | | | | | |
| BIP6B64 | BIP6B64 | 1 | 11 | ReceivedSum | BIP6B643_T | UDR | 2 | RECEIVED_SUM | 0 | N/A |
| 3_T6101 | 3_T6101 | | | | 6101604_1_0 | Rsp | | | | |
| 604_1_0 | 604_1_0 | | | | 1_0 | | | | | |
| 1_3 | | | | | | | | | | |
| BIP6B64 | BIP6B64 | 1 | 11 | SuccSum | BIP6B643_T | UDR | 3 | SUCC_SUM | 0 | N/A |
| 3_T6101 | 3_T6101 | | | | 6101604_1_0 | Rsp | | | | |
| 604_1_0 | 604_1_0 | | | | 1_0 | | | | | |
| 1_4 | | | | | | | | | | |
| BIP6B64 | BIP6B64 | 1 | 11 | Failed | BIP6B643_T | UDR | 4 | FAILED_NUM | 0 | N/A |
| 3_T6101 | 3_T6101 | | | Sum | 6101604_1_0 | Rsp | | | | |
| 604_1_0 | 604_1_0 | | | | 1_0 | | | | | |
| 1_5 | | | | | | | | | | |
| BIP6B64 | BIP6B64 | 1 | 3 | Failed | BIP6B643_T | UDR | 5 | N/A | 0 | N/A |
| 3_T6101 | 3_T6101 | | | BData | 6101604_1_0 | Rsp | | | | |
| 604_1_0 | 604_1_0 | | | | 1_0 | | | | | |
| 1_6 | | | | | | | | | | |
| BIP6B64 | BIP6B64 | 1 | 10 | OprNumb | BIP6B643_T | Failed | 0 | TRANS_ID | 0 | N/A |
| 3_T6101 | 3_T6101 | | | | 6101604_1_0 | BData | | | | |
| 604_1_0 | 604_1_0 | | | | 1_6 | | | | | |
| 1_7 | | | | | | | | | | |
| BIP6B64 | BIP6B64 | 1 | 10 | MSIS | BIP6B643_T | Failed | 1 | IS_SUCCESS | 1 | IS_SUCCESS-FALSE |
| 3_T6101 | 3_T6101 | | | DN | 6101604_1_0 | BData | | | | |
| 604_1_0 | 604_1_0 | | | | 1_6 | | | | | |
| 1_8 | | | | | | | | | | |
| BIP6B64 | BIP6B64 | 1 | 10 | Rslt | BIP6B643_T | Failed | 2 | REMOTE_RSLT_CODE1 | 0 | N/A |
| 3_T6101 | 3_T6101 | | | | 6101604_1_0 | BData | | | | |
| 604_1_0 | 604_1_0 | | | | 1_6 | | | | | |
| 1_9 | | | | | | | | | | |
| BIP6B64 | BIP6B64 | 1 | 11 | RspPkgSeq | BIP6B643_T | UDR | 6 | PKG_IS_SUCCESS | 1 | PKG_IS_SUCCESS-TRUE |
| 3_T6101 | 3_T6101 | | | | 6101604_1_0 | Rsp | | | | |
| 604_1_0 | 604_1_0 | | | | 1_0 | | | | | |
| 1_10 | | | | | | | | | | |
| BIP6B64 | BIP6B64 | 1 | 11 | RspPkgSeq | BIP6B643_T | UDR | 7 | RETURN_TYPE | 1 | RETURN_TYPE-PKG_TYPE |
| 3_T6101 | 3_T6101 | | | | 6101604_1_0 | Rsp | | | | |
| 604_1_0 | 604_1_0 | | | | 1_0 | | | | | |
| 1_11 | | | | | | | | | | |
| BIP6B64 | BIP6B64 | 1 | 11 | RspPkgSeq | BIP6B643_T | UDR | 8 | RETURN_BUSI_SIGN | 1 | RETURN_BIP6B643_{—} |
| 3_T6101 | 3_T6101 | | | | 6101604_1_0 | Rsp | | | | T6101602_0_0 |
| 604_1_0 | 604_1_0 | | | | 1_0 | | | | | |
| 1_12 | | | | | | | | | | |

### TD_B_IBSIMPLE_ESCAPE

| | | | |
|---|---|---|---|
| RETURN_TYPE-PKG_TYPE | * | N/A | PKG_TYPE |
| RETURN_TYPE-TRANS_TYPE | * | N/A | TRANS_TYPE |
| PKG_IS_SUCCESS-TRUE | * | N/A | TRUE |
| PKG_IS_SUCCESS-FALSE | * | N/A | FALSE |
| IS_SUCCESS-TRUE | * | N/A | TRUE |
| IS_SUCCESS-FALSE | * | N/A | FALSE |
| KIND_ID-BizType | BIP2B110_T2001101_0_0 | N/A | 10 |
| TESTFLAG-IDType | * | N/A | 1 |
| TESTFLAG-HomeProv | * | N/A | 871 |
| TRANS_TYPE | * | N/A | TRANS_TYPE |
| KIND_ID-BizType | BIP2B248_T2101111_0_0 | N/A | 52 |
| PKG_TYPE | * | N/A | PKG_TYPE |
| RETURN_BIP6B643_T6101602_0_0 | * | N/A | BIP6B643_T6101602_0_0 |

F_UIP_GET_PKG_ID: This is the function for generating package sequence number. It needs to be implemented if certain transaction requires generating package sequence number.

| | |
|---|---|
| Input parameters: | |
| IN_BUSI_SIGN | the identification of the business |
| IN_PROVINCECODE | province code |
| IN_PKG_ORDER | the order number of the package |
| Output parameters: | |
| RESULT | generated package sequence number |

F_UIP_GET_TRANS_ID: This is the function for generating operating sequence number. It needs to be implemented if certain transaction requires generating package operating sequence number.

| | |
|---|---|
| Input parameters: | |
| IN_BUSI_SIGN | the identification of the business |
| IN_PROVINCECODE | province code |
| IN_SYN_LOG_ID | sequence number in |
| | TL_B_IBPLAT_SYN_LOG |
| Output parameters: | |
| IN_SEND_NO | how many times data have been sent |
| RESULT | generated operating sequence number |

NOTES: Operating sequence number is synchronized to the field TRANS_ID in TL_B_IBPLAT_SYN. If there exists return data, the system update the result according to TRANS_ID. In the case of file interface, if some information would be returned, TRANS_ID should be created as file name followed by “_” and mobile number when originate sending to correspond with the data returned.

Adapter of the result returned asynchronously at home domain is: com.linkage.ngi.thread.platSyn.processor.PlatSynchAffimSender

For those transactions which has a request desiring to be confirmed by originate in returned information of home domain, the request would be sent back according to the value of TRANS_ID as the corresponding point of the originate sending transaction and the home return transaction.

### Essential Input Fields for BML:

RETURN_BUSI_SIGN: This field should be assigned to with the value of the field BUSI_SIGN in corresponding originate sending transaction.

RETURN TYPE: This field could be configured as “PKG_TYPE” or “TRANS_TYPE”. Former case updates according to package sequence number, and latter case according to operating sequence number.

PKG_ID: If the value of RETURN_TYPE equates to “PKG_TYPE”, this field must be assigned to;

PKG_IS_SUCCESS: This field could be “TRUE” or “FALS”. If RETURN_TYPE equates to “PKG_TYPE”, this field must be assigned to;

TRANS ID: This field shows the operating sequence number in returned information, which must equates to the sequence number of originate transaction. Referring to file interface without sequence number, it should be created as file name followed by “_” and mobile number when sending the file.

IS_SUCCESS: This field could be “TRUE” or “FALS”, representing whether the return transaction succeeds or not.

REMOTE_RSLT_CODE1. REMOTE_RSLT_DESC1. REMOTE_RSLT_CODE2. REMOTE_RSLT_DESC2. REMOTE_RSLT_CODE3. REMOTE_RSLT_DESC3: If the first grade return code, the second grade return code and the third grade return code are returned, these fields should befilled.

Fetch data in TL_B_IBPLAT-SYN. Assign “ [symbol] ” to BUFFER NAME.

Fetch data in TL_B_IBPLAT_SYN_LOG. Assign “LOG. [symbol] ” to BUFFER_NAME.

Fetch data in TL_B_IBPLAT_SYN_SUB. Assign “SUB. [symbol] ” to BUFFER_NAME.

Fetch data in TL_B_IBPLAT_SYN_RSLT_SUB. Assign “RSLT. [symbol] ” to BUFFER_NAME.

### TD_B_IBSIMPLE_ESCAPE

This table is used to configure the converting regulation of fixed data like IDtype and province code. Converting regulation of others like user state, user brand and operating type also can be configured in this table.

| | | ESCAPE_ID | | SELF_INFO | | DEPEND_INFO | | TRANS_VALUE | |
|---|---|---|---|---|---|---|---|---|---|
| [symbol] | 1 | RETURN_TYPE-PKG_TYPE | . . . | * | . . . | N/A | . . . | PKG_TYPE | . . . |
| | 2 | RETURN_TYPE-TRANS_TYPE | . . . | * | . . . | N/A | . . . | TRANS_TYPE | . . . |
| | 3 | PKG_IS_SUCCESS-TRUE | . . . | * | . . . | N/A | . . . | TRUE | . . . |
| | 4 | PKG_IS_SUCCESS-FALSE | . . . | * | . . . | N/A | . . . | FALSE | . . . |
| | 5 | IS_SUCCESS-TRUE | . . . | * | . . . | N/A | . . . | TRUE | . . . |
| | 6 | IS_SUCCESS-FALSE | . . . | * | . . . | N/A | . . . | FALSE | . . . |
| | 7 | BusiProc-UserStatus | . . . | 1 | . . . | N/A | . . . | 02 | . . . |
| | 8 | BusiProc-UserStatus | . . . | D | . . . | N/A | . . . | 02 | . . . |
| | 9 | BusiProc-UserStatus | . . . | C | . . . | N/A | . . . | 02 | . . . |
| | 10 | BusiProc-UserStatus | . . . | B | . . . | N/A | . . . | 01 | . . . |
| | 11 | BusiProc-UserStatus | . . . | A | . . . | N/A | . . . | 01 | . . . |
| | [symbol] | [symbol] | . . . | [symbol] | . . . | [symbol] | . . . | [symbol] | . . . |

[symbol]

indicates data missing or illegible when filed

The field SELF_INFO holds the information got from source data. Only if the configuration matches with the actual information, the value of DEPEND_INFO would be took into account. After successful matching between the value of DEPEND_INFO and the actual information, the value of TRANS_VALUE would be returned.

For example, look at the fifth record in above table.

“IS_SUCCESS-TRUE' shows this configuration is used for user state converting. If the actual information got from source data is “D”, “02” would be returned.

The default value of SELF_INFO is configured as “*”. When no conditions are matched, the value of TRANS_VALUE in this default configuration would be returned.

| | | | | | |
|---|---|---|---|---|---|
| 5 | IS_SUCCESS-TRUE | . . . * | . . . N/A | . . . TRUE | . . . |
| 6 | IS_SUCCESS-FALSE | . . . * | . . . N/A | . . . FALSE | . . . |

IS_SUCCESS-TRUE: return “TRUE”

IS_SUCCESS-TRUE: return “FALSE”

If the value of DEPEND_INFO is configured as “N/A”, only the field SELL_INFO must be compared. Usually, the value of DEPEND_INFO is configured as “BUFFER_NAME:VALUE| BUFFER_NAME:VALUE”, separating each “BUFFER_NAME:VALUE” with “|”. The information ace should agree with occ of SELF _INFO.

| | | | | | |
|---|---|---|---|---|---|
| 34 | BusiProc-UserStatus | . . . 0 | . . . ID: 11NAME: 55 | . . . 02 | . . . |
| 35 | BusiProc-UserStatus | . . . 0 | . . . ID: 34NAME: 56 | . . . 01 | . . . |
| 36 | BusiProc-UserStatus | . . . 0 | . . . ID: 23NAME: | . . . 00 | . . . |
| | | | 78[VALUE: 1] | | |

Taking above three records for instance, if the value of BUFFER_NAME is equal to “0”, further comparison would be made between the actual message and the value of DEPEND_INFO.

If ID=23,NAME=78,VALUE=11,return 00.

If ID=34,NAME=56,return 01.

If ID=11,NAME=55,return 02.

TD_B_IBCOMPLEXE_ESCAPE

This table is used to configure complicate conversion relation. There are three convert patterns classified by the value of the field ESCAPE_TYPE. Exactly, “00” corresponds to using escape class, “01” corresponds to configuring Sql statement, “02” corresponds to calling escape function.

While using escape class, the value of the field ESCAPE_INFO shows the class name in full path.

Escape function should be located in com.linkage.ngi.translator.cctranslator package to inherit from CCEscapeTranslator class.

public String getXmlValue(String BUFFER_NAME, BML bml, String occ) throws Exception;

Description: get data with XML structure from a segment with BML structure

public ArrayList getXmlValueList(String BUFFER_NAME, BML bml, String occ) throws Exception;

Description: get data with XML structure from a segment with BML structure in batches

public String getBmlValue(Node node, BML bml) throws Exception;

Description: get data with BML structure from a segment with Node structure

NOTES: These three functions modify data not only through assigning return value to certain variable but also through modifying data of the input object BML/Node.

For example:

| | | ESCAPE_ID | | ESCAPE_TYPE | ESCAPE_INFO | |
|---|---|---|---|---|---|---|
| | 1 | TIME-getCurrentTime | . . . | 00 | com.linkage.ngi.translator.cctranslator.CCTimeEscapeTranslator | . . . |
| | 2 | PASSWORD-encrypt | . . . | 00 | com.linkage.ngi.translator.cctranslator.CCPasswordEncryptTranslator | . . . |
| | 3 | PASSWORD-decrypt | . . . | 00 | com.linkage.ngi.translator.cctranslator.CCPasswordDecryptTranslator | . . . |
| | 4 | PASSWORD- | . . . | 00 | com.linkage.ngi.translator.cctranslator.CCPasswordGenerateShaTranslator | . . . |
| | | generateSha | | | | |
| [symbol] | 5 | Dual-Seq | . . . | 01 | SELECT F_UIP_GETSEQID[:SEQ_NAME]SEQ FROM DUAL | . . . |
| | 6 | Crtt-update | . . . | 00 | com.linkage.ngi.translator.cctranslator.CCDSMPOprNumbTranslator | . . . |
| | | TranID-DSMPUDR | | | | |

TIME-get:CurrentTime: get current: time;

PASSWORD-encrypt: encrypt password:

PASSWORD-decrypt: decrypt password:

Dual-Seq: get Sequence;

Crtt-updateTranID-DSMPUDR: Synchronize the value of Crtt to DSMP order relation, and update transaction sequence number according to it.

Sql statement: Assign the queried Sql statement with only one return value to ESCAPE_INFO.

This Sql statement could have input parameters which must be defined with “:” as prefix and usually named after fields in BML.

Taking Dual-Seq as an instance, the Sql “SELECT F_UIP_GETSEQID(:SEQ_NAME) SEQ FROM DUAL” should be offered with “Bml.Bchg(“SEQ_NAME”, 0,seq_uip_sysid”):”.

Escape function: This function would be implemented as a text using javaScript, which could be directly assigned to ESCAPE_INFO and directly called by programs.

In the case of converting BML structure to XML structure, after offering values to input parameters of the script (buffername, occ, buffervalue, bmlstring), the output parameter returnstr would be returned.

In the case of converting XML structure to BML structure, after offering values to input parameters of the script (xmlvalue.occ, xmlname, bmlstring), the output parameter retumstr would be returned.

What is claimed is:

1. An implementation method of DATACOM Data Command Platform comprising:
Taking the characteristic of data business into account, DATACOM system working on the data command platform, which is both data processor and data general converter, completes both command protocol conversion and command contents conversion, after the conversion of the opening command of data business from BOSS to the opening command of network element (NE) data, business opening, including single business and a batch of business, NE scheduling and load balancing are all achievable. Meanwhile, troubles are compatible;
(1) Data Source Configuration: since all the business commands like opening/canceling from BOSS share a scheduling table and lots of NE bring about large amounts of this business data, the scheduling table should be split, in this condition, the name of data source table should be configured by some parameters before fetching data to ensure the consistence between applications, DataCom application assigns itself a fixed ID according to which the right data source table name of this application can be fetched from parameter table. In this way, it ensures the data source is configurable;
(2) Configuration of Data Source Differences: for the sake of configuring data source as former steps, source data provider should know about the source data on the basis of existing configurations to guarantee the accuracy of data sent before sending, therefore, a set of tables for data accuracy check before sending is designed in DataCom application;
(3) Data Command Configuration: while data passes the platform, data command can be generated directly by configuring data command but not modifying program and sent to the corresponding receiving NE;
(4) NE Data Configuration: there have been multitudes of NE. Furthermore, this size increases with the development of business this system offers a selective Data command transmitting if different network elements need to be transmitted to, in case many interdependent network elements should be sent to, this business will be dealt with according to the interdependency;
(5) Configuration of Generating Data Command: Data command consists of command head and command body, which are both different as a result of the differences between network elements, therefore, when command generated, the head should be got according to the corresponding NE kind and then the body could be got from the corresponding data source;
After reading command information, DATACOM would get configuration information referring to the key constituted by NE and command ID for different network elements, Data command can be assembled in many ways: 1) the command in XML format, is firstly translated to the data in general XML format, and then converted to the information in the required XML format by the NE through XSLT conversion, the first step of which is reading the XSLT configuration file with the Key; 2) for the command which has a large amount of data and desires a very high performance, the required XML format by the NE can be got directly by analytical adapter(analytical class), the Key dependent on the information of the interface determines which analytical adapter is suitable; after loading the suitable analytical adapter, content of the command is converted to the information in final XML format; 3) for the command which has a lower requirement about performance than former, dynamical analysis is also practicable, this method stores the command in a configuration table, splitting the command content into records of the table; the relation between the records forms a tree structure, which can present either XML format or fixed length string, the program generates the command content in accordance with this structure.

2. The implementation method of DATACOM data command platform of claim 1, wherein the supporting mechanism is of multiprocessing, when processing data with single data source, this platform configures the kind of the involved NE to sustain this characteristic.

3. The implementation method of DATACOM data command platform of claim 1, wherein the platform is the portability of applications, it's applicable for the data interaction between network elements of all telecommunication operators such as China Mobile, China Unicom and China Telecommunications; to process different commands, only the configuration, not the scheduling program, needs to be changed.

4. The implementation method of DATACOM data command platform of claim 1, wherein through packaging the protocol adapter unit, the format configuration unit and the particular business processing unit, diversity of NE is shielded, convertible command protocol includes HTTP receiving/sending, Tuxedo invoking/invoked, SMS interface, Soap, ftp, MML, Socket. In addition, format conversion of XML and string split by symbols and command content conversion which is configurable are completed, too.

5. The implementation method of DATACOM data command platform of claim 1, wherein Data scan/distribution unit takes charge of data extraction, multi-host load balance, command sending control between many network elements, in addition, Command scheduling works on the basis of business priority, command sending order and command amount.

6. The implementation method of DATACOM data command platform of claim 1, wherein there is a preprocessing before fetching data into cache. For one trade, it perhaps needs to send command to many network elements or send many commands to one network element; it is necessary to adjust the dependency relationship between data and the priority of command sending. If there is some causality, the relation information and the executing order are also need to be set; the commands with the same causal relation information should be executed according to the order set up one after another; when an exception is thrown out, the subsequent commands will be terminated consequently.

7. The implementation method of DATACOM data command platform of claim 6, wherein If there is a series of businesses to be handled in sequence for the same number, it can be done by the way of changing some configuration of the trade, such as defining a script using Java script or a procedure, regulating data by SQL statements to combine one or several schemas.

8. The implementation method of DATACOM data command platform of claim 1, wherein after decomposition, the command is recomposed according to command ID and NE ID in line with the feature of NE.
